(19) United States
(12) Patent Application Publication
(10) Pub. No.: US 2015/0288619 A1
(43) Pub. Date: Oct. 8, 2015

(54) DISTRIBUTED SERVICE MANAGEMENT PLATFORM

(71) Applicant: Minerva Networks, Inc., Alviso, CA (US)

(72) Inventor: Jean-Georges Fritsch, Los Altos, CA (US)

(21) Appl. No.: 14/677,469

(22) Filed: Apr. 2, 2015

Related U.S. Application Data
(60) Provisional application No. 61/975,595, filed on Apr. 4, 2014.

(51) Int. Cl. H04L 12/931; H04L 12/24; H04L 12/26

(52) U.S. Cl. CPC H04L 49/206; H04L 43/0894; H04L 41/5025

(57) ABSTRACT

Distributed service management platforms and methods are provided herein. In one system includes a back office that provides a media delivery service and a service acceleration system having a plurality of geographically distributed edge nodes for a plurality of clients, and a load manager that monitors latency experienced by each of the plurality of clients when requesting media services and selectively chooses a node for each of the plurality of clients based upon the latency experienced by each of the plurality of clients. Latency is due to lack of CPU availability in one or more of the plurality of the nodes as well as network traffic.

### CROSS REFERENCE TO RELATED APPLICATIONS

This application claims the priority benefit of U.S. Application Ser. No. 61/975,595, filed on Apr. 4, 2014, which is hereby incorporated by reference herein in its entirety, including all references cited therein.

### FIELD OF THE INVENTION

The present technology pertains to service management systems and methods and more specifically, but not by way of limitation, to a distributed service management platform that is configured to deliver requested services in such a way that end users of these services experience only acceptable levels of latency when accessing or otherwise using the requested services.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system, including: a back office that provides a service; and a service acceleration system including a plurality of geographically distributed edge nodes for a plurality of clients. The system also includes a load manager that monitors latency experienced by each of the plurality of clients when requesting service data and selectively chooses one of the plurality of geographically distributed edge nodes for the plurality of clients based upon the latency experienced by each of the plurality of clients, where the latency is due to lack of CPU availability in one or more of the plurality of the nodes. Other embodiments of this aspect include corresponding computer systems, apparatus, and computer programs recorded on one or more computer storage devices, each configured to perform the actions of the methods.

One general aspect includes a load manager, including a processor and a memory for storing executable instructions, the processor executing the instructions to: monitor latency experienced by a client when requesting and receiving media service data from a current edge node in a network. The current edge note is configured to: receive a media service request from a client over a network; provide the media service request to a back office that persistently maintains media service data; configure the media service data for the client in such a way that the client need only display the media service data; and transmit the configured media service data to the client. The processor also executes instructions to determine if the latency exceeds a latency threshold; determine a new edge node in a network that is available to service requests for media service data from the client, the new edge node having a latency that does not exceed the latency threshold; and transfer the client to the new edge node.

Other embodiments of this aspect include corresponding computer systems, apparatus, and computer programs recorded on one or more computer storage devices, each configured to perform the actions of the methods.

One general aspect includes a method, including: providing predictive search service in an edge node of a media service network, the media services network further including a back office that maintains persistent media service data, where the back office controls placement of the edge node within the media service network. The method also includes receiving textual input from a client communicatively coupled to the media service network. The method also includes executing a predictive search within the edge node using the textual input and predictive search dictionary. The method also includes transmitting in real-time to the client predictive search results. Other embodiments of this aspect include corresponding computer systems, apparatus, and computer programs recorded on one or more computer storage devices, each configured to perform the actions of the methods.

One general aspect includes a thin client, including: a processor; and a memory for storing executable instructions, the processor executing the instructions to: receive from load manager two or more IP addresses of edge nodes that are configured to provide media service data to the thin client, the edge nodes cooperating with a back office to deliver the media service data to the client; actively determine latency between each of the edge nodes and the thin client that are related to provision of the media service data to a user; and dynamically switch between edge nodes based on the latency. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an example system in the form of a distributed service management platform.

FIG. 2 is a schematic diagram that illustrates the dynamic reconfiguration of the distributed service management platform of FIG. 1 in response to latency metrics.

FIG. 3 is a flow diagram illustrating the operation of the distributed service management platform in a first instance.

FIG. 4 is a flow diagram illustrating the operation of the distributed service management platform after dynamic reconfiguration due to shifting edge node responsibility.

FIG. 5 is a flowchart of an example method for distributed service management.

FIG. 6 is a signal flow diagram illustrating a distributed service management process.

FIG. 7 is a flowchart illustrating another example method for distributed service management.

FIG. 8 is a schematic diagram of an example edge node.

FIG. 9 illustrates an exemplary computing system that may be used to implement embodiments according to the present technology.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Recently there has been an explosion in the number of devices that consumers use to access requested services such as video content, whether it is a PayTV server from an operator or an over the tope (OTT) service from a Netflix™, Hulu™ or Youtube™. At the same time we have also seen a rapid adoption of cloud computing. While cloud computing helps to reduce operating expenses and enables software as a service (SaaS) business models, the inherent drawback is that the network connectivity between the device and the service, running in the cloud, becomes very important. Any network congestion will translate into an unresponsive service meaning that the customer will experience latency issues such as slow content delivery, slow loading of graphical user interfaces (GUIs), and so forth. This may be acceptable for banking or email services, but for a TV service consumers find latency unacceptable.

The present technology disclosed herein pertains to a novel architecture that enables the delivery of a very responsive user experience by introducing a distributed architecture for providing services. This distributed architecture is created by distributing the computation power (in addition to storage) throughout a media delivery network. In some embodiments, the distributed computation power is placed in strategic locations to minimize network latency and network traffic. This architecture enables moving functionalities that typically run in the device to the network. As a result, lower-end devices with limited central processing unit (CPU) and memory can run the requested service. Additional benefits include applications that can be developed in HTML type languages that are very portable and hence enable the immediate availability of the service as devices become available. This allows the clients to operate as thin devices. For example, the thin clients need only be able to display media service data and receive input from an end user.

Complex and CPU intensive processes are shifted to the distributed network of edge nodes such as UI rendering for device compatibility, predictive searching capabilities for media services, as well as other CPU intensive processes that are commonly required by set-top-boxes (STB) and other media delivery devices.

To be sure, the present technology allows media service companies to deploy media services, applications, and other updates for execution in the edge nodes of the network rather than requiring flashing and updating of clients, which can be onerous. Indeed, media service companies cannot easily deploy menu and UI changes or detailed application and/or service changes due to lack of consistency between clients. That is, customers may use many types of client device such as STBs, laptops, Smartphones, tablets, and so forth to access media services. Furthermore, the ubiquity in these devices has led to vast differences even in individual client types such as STBs. When a service update or media services is delivered to STBs with different capabilities, some clients may be unable to utilize or implement the service update or media services. Thus, media services companies can expend tremendous time and cost ensuring that most clients will be able to continue being serviced. Often, updates in media services require flashing or updating of firmware and/or software in the clients. These software and firmware updates can themselves cause unwanted issues when implemented on the client if not tested properly, due to a lack in consistency and homogeneity of client devices.

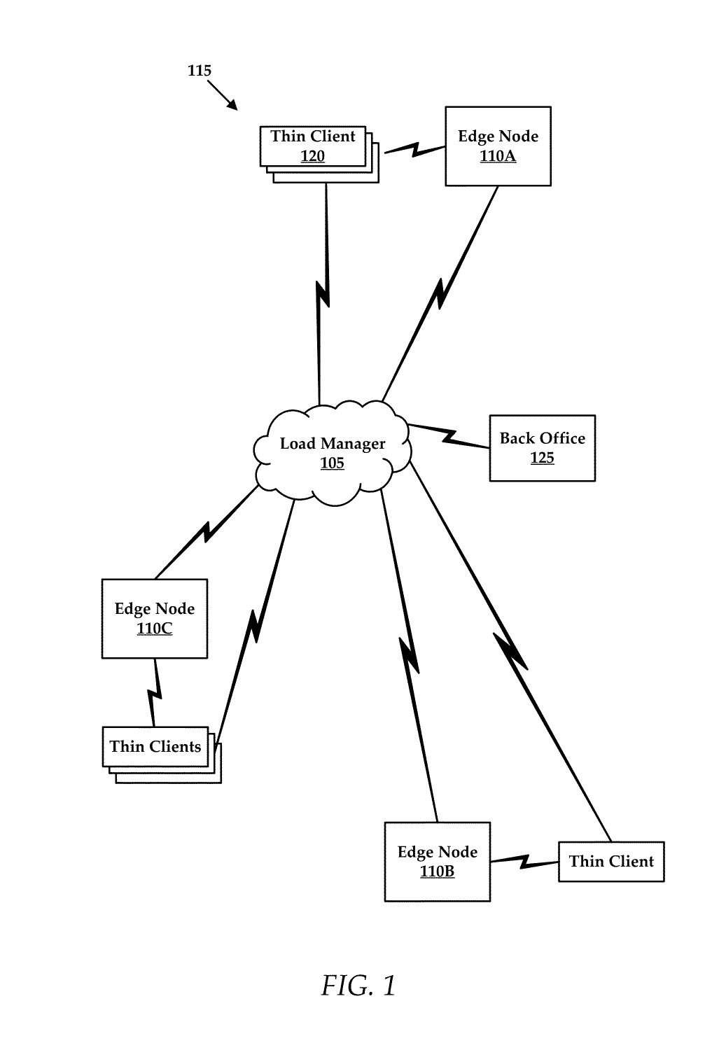

FIG. 1 illustrates a distributed service management network that generally comprises a load manager 105, a plurality of edge nodes such as edge node 110A, edge node 110B, and edge node 110C, as well as thin clients such as thin client 120, and a back office 125.

The back office 125 provides a service, such as pay television TV, video on demand (VoD), cable TV, as well as other media service data that would be known to one of ordinary skill in the art. To be sure, the terms media service data may also be referred to herein as a media service or just a service. The plurality of edge computing nodes (edge node 110A, edge node 110B, and edge node 110C) are distributed geographically so as to be proximate to thin clients that are used by customers.

As will be noted throughout, the present technology provides an edge node platform or network that can be used to accelerate any service provided to an end user or other network. To be sure, while examples provided herein mention the use of the distributed service management network to provide accelerated media delivery services, the distributed service management network to provide accelerated media delivery services, the distributed service management network is not limited to providing media delivery services. For example, the distributed service management network can be utilized in the provision of home security services, home automation services (e.g., smart home services), smart grid technology, smart city and infrastructure, and electronic healthcare services—just to name a few.

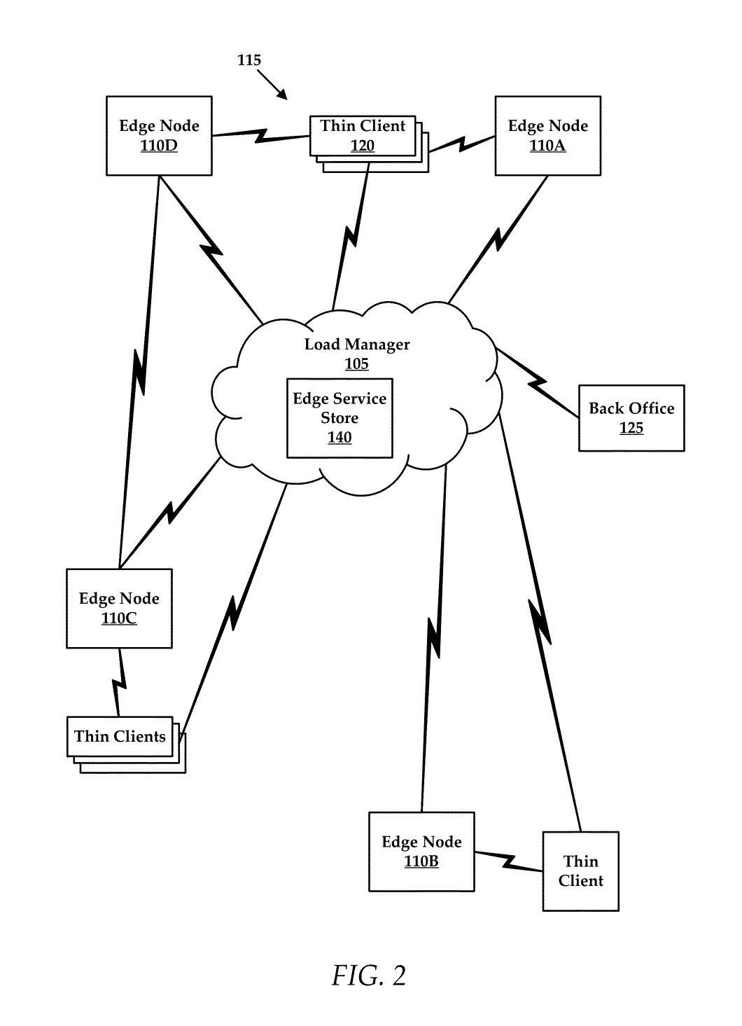

Each of the edge nodes can be implemented on a physical server (or virtualized on a physical server). An edge node has three logical interfaces. A first interface communicatively couples with the back office 125 of the service hosted, for example, in a cloud-computing environment. A second interface communicatively couples with other nodes in the network. For example, edge node 110D (FIG. 2) can communicatively couple with edge node 110C (FIG. 2). To be sure, the plurality of edge nodes can be interconnected over the network to form a mesh or edge node network.

A third interface allow for communicative coupling with thin clients, such as thin client 120.

Computing intensive functions such as GUI construction, caching, and delivery, as well as user credentialing and authentication, media caching, and other computing functions that may traditionally be executed by a client terminal such as a set-top-box, a Smartphone, a tablet computer, a laptop computer, or other similar end user device may be executed at one or more of the edge nodes. Advantageously, an edge node may be located geographically proximate to a thin client that the edge node services so as to reduce network latency when delivering services.

For example, edge node 110A services a thin client group 115 (FIG. 2) that comprises the thin client 120. Each of the edge nodes can service one or a plurality of thin clients.

In some examples, edge nodes may be located in a city, a neighborhood, or even as granularly as being located within the user's home. For example, an edge node may include an access point, router, or switch within the user's home. An edge node may also be running in a network device in the media service's network like an edge router or digital subscriber line access multiplexer (DSLAM), cable modem termination system (CMTS), wireless base station, or other network device.

The present technology can be implemented on any other suitable network which may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including 4GLTE (Long Term Evolution), 3GPP (3G Radio Access Network), WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

As mentioned above, an edge node may be configured to execute various functions such as subscriber authentication, subscriber entitlement, service personalization, metadata processing, user experience cashing, user interface and user experience state caching, analytic and quality of experience data collection, as well as inter-node synchronization, and other functions that are currently executed in a legacy services system that may lead to latency on the customer's device.

In some embodiments, the edge nodes and the thin client can cooperatively implement a media services application. The entirety of the media services application would be that application which would traditionally execute entirely on, for example, a STB.

In the present technology, a first portion of the media services application will reside and execute on the edge node. This first portion will include any CPU intensive activities as those mentioned in the previous paragraph. A second portion of the media services application will reside and execute on the thin client. This second portion includes, for example, only simply UI display capabilities and user input features. Thus, the user can input requests through the thin client and receive their requested media services without requiring the thin client to be overloaded with CPU intensive processes.

In one embodiment, the thin client 120 comprises only an HTML application that receives user input and displays content received from a currently assigned edge node.

According to some embodiments, an edge node can store media service data in cache memory to reduce latency for request for the media service data from the plurality of clients. That is, rather than requiring the edge node to obtain frequently requested content from the back office 125, the edge nodes can be configured to maintain in cache memory certain media service data.

In some embodiments, edge nodes are configured to cache metadata for the media service data to improve delivery of electronic program (EPG) data, video on demand (VOD) data, and other outbound content metadata over a network.

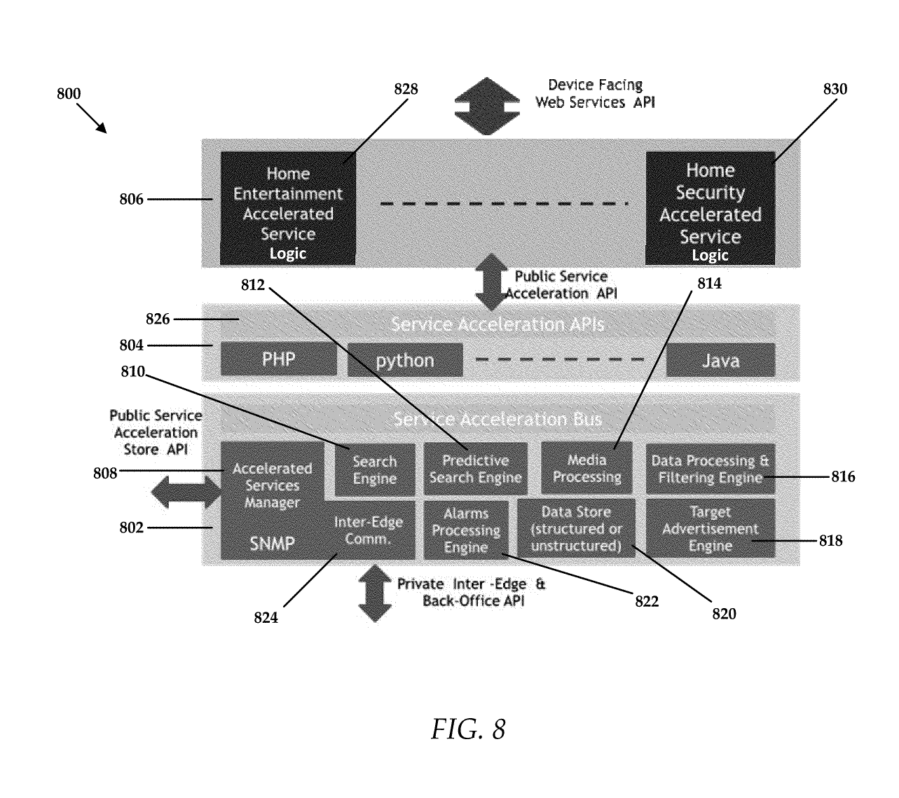

An example edge node is illustrated in FIG. 8 and described in greater detail below.

The load manager 105 is configured to control the distribution of computing services in the network by dynamically reconfiguring the architecture of the system. In some embodiments, the dynamic reconfiguration can include reassigning an existing edge node to service a thin client experiencing latency. In another embodiment, the dynamic reconfiguration can include instantiating new edge nodes to service a thin client experiencing latency when no existing edge nodes are available to service the thin client.

To be sure, the load manager 105 can be configured to provide real time switching of thin clients from one edge node to another in order to preserve a responsive service experience for end users. Thus, when one edge node is causing an unresponsive service experience in one or more thin clients, due to latency issues, the load manager 105 can switch the thin clients to another edge node that can provide a more responsive user experience.

In some embodiments, distribution of computing power for thin clients by the load manager 105 is based on central processing unit (CPU) load within the edge nodes. In other words if the CPU load on a given server (e.g., edge node) has reached a certain level, additional servers running the software are brought online and thin clients are redirected to these additional servers.

Thus, the load manager 105 can be configured to store and implement CPU usage thresholds for each of the edge nodes. The load manager 105 can detect CPU usage at each of the edge nodes and compare the measured CPU usage to the CPU usage threshold and dynamically reconfigure the edge node distribution based on the comparison.

With regard to the present technology, the network will bring online or wind down edge nodes, not only based on CPU load, but also based on network latency. Network traffic can fluctuate throughout the day and that network load may be local, regional or global. As a result the distribution of the computing within the network is based on a constant monitoring of the network latency between the client device and the edge. On a regular interval thin clients can report to the load manager 105 their latency (median and mean) they are experiencing when they reach out to their assigned edge node.

If the reported latencies are higher than the high-threshold the load manager 105 redirects the device to another edge node (e.g., new edge node) that has a lower latency that the current edge node.

Referring to FIG. 2, if the load manager 105 determines that the thin client 120 is experiencing in excess of one seconds of load time for a GUI, and the acceptable threshold is less than three hundred milliseconds, the load manager 105 redirects the thin client 120 from edge node 110A to edge node 110D. To be sure, edge node 110D is instantiated because edge node 110C and 110B are both unable to provide the requisite services at the desired latency level.

To be sure, latency can be assessed for individual tasks or for overall performance. For example, latency thresholds can be established for GUI load times, media display times (e.g., how long it takes to load a selected media asset), predictive search query times, and so forth.

In some embodiments, latency relates to a user experience of the thin clients coupled with the edge nodes of the architecture. In other embodiments, latency is reduced relative to other metrics associated with, for example, machine-to-machine networks. To be sure, in machine-to-machine (M2M) networks, latency does not affect an end user experience per se, but can interfere with robust operations of the M2M network. Thus, thin end point devices in an M2M network can be utilized in place of more computing intensive end point devices, while compute intensive processes are pushed to the edge network where services can be accelerated thus improving overall performance of the M2M network. For example an M2M smart home architecture could incorporate a plurality of thin client machines associated with various appliances in a home. Any compute intensive functions required to provide a service at a given appliance, such as a home security panel or a smart refrigerator, can be executed in the edge node portion of the network where service acceleration applications are executed. To be sure, M2M networks can exist in factories, vehicles, buildings, schools, cities, and homes—just to name a few.

If on the other hand, no lower latency edge node is available, then the load manager 105 notifies the thin client 120 that no better option is available. The load manager 105 may also instantiate additional edge nodes that are in standby and redirect the devices to them as appropriate. When the latency between the client and an edge node falls below a low threshold then the load manager 105 may redirect devices to another edge node in order to reduce the number of active edge nodes. Thus, the load manager 105 can selectively deactivate edge nodes when thin clients do not require services.

According to some embodiments, the edge nodes need not be geographically distributed, but can be collocated with the back office. For example, if the back office and thin clients are coupled on a fiber network, latency is generally reduced. Nevertheless, the present technology provides advantages in these instances by offloading CPU intensive processes to the edge nodes. Thus, even when network latency is not an issue, CPU latency can still affect the user experience. The present technology provides advantages by offloading these processes to the edge nodes.

In some embodiments, the load manager 105 is configured to, in real-time, switch the thin client 120 to edge node 110D. The load manager 105 is configured to load service acceleration instructions on the edge node 110D. In one embodiment, the edge node 110D can be instantiated by the load manager 105 when the load manager 105 determines that the edge node 110A is not providing a responsive user experience. That is, edge node 110D may not exist until needed by the load manager 105 due to latency issues. The load manager 105 can create a virtual machine for the edge node 110D. When the thin client 120 requests a service the edge node 110D can download the service acceleration application from an edge service store 140.

In some embodiments, an edge node can remove any installed service acceleration applications when the service acceleration application is idle. In some embodiments, an edge node (or the load manager 105) can utilize heuristic logic to provide just-in-time loading of service acceleration applications based on service usage patterns. Thus, the load manager 105 or individual edge nodes can track thin client usage patterns and predictively download and install service acceleration applications in a manner that is transparent to the user. For example, the service acceleration application download and installation process can occur in such a way that it does not impact the end user service experience.

In some embodiments, the edge service store 140 is collocated with the load manager 105 and can provide a repository or marketplace of certified acceleration applications. As mentioned herein, the exact features provided by the service acceleration applications will vary according to the service being provided. That is, while some embodiments contemplate service acceleration during the delivery of media services, the present technology can be utilized to accelerate other services such as smart home technology and electronic healthcare services, as well as other services that would be known to one of ordinary skill in the art with the present disclosure before them.

In some embodiments, the edge node services provided herein can be accessed through the use of an application programming interface (API) through which a third party can integrate their own service acceleration applications.

Additional features that can be provided by an edge node include, but are not limited to, loading and removing of service acceleration applications, collection of key performance indicators (KPI) for a service acceleration application which are provided back to the edge service store 140. In some embodiments, the edge node platform of the present technology utilizes a flexible execution environment implemented in Java, JavaScript, Python, PHP, or other suitable language.

In some embodiments, the edge node platform can provide a set of APIs that enable applications to mesh canonic services accelerated by the edge network to create new, rich, and converged services.

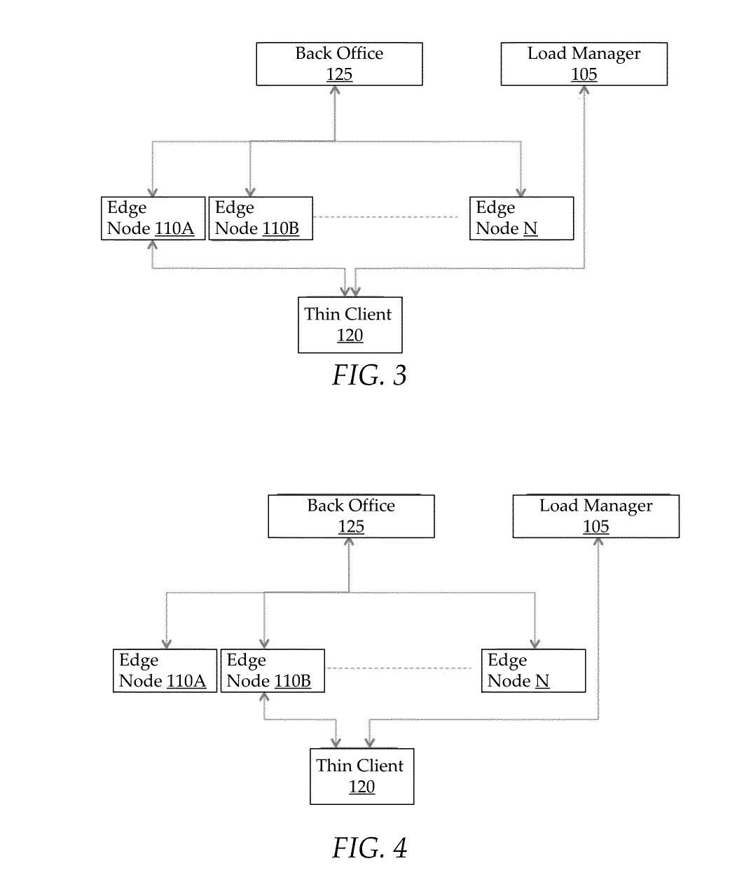

FIG. 3 illustrates a network arrangement that includes a cloud instance of the Back Office 125 which provides services to a Thin Client 120. A plurality of edge node such as Edge Node 110A-110N act as computational proxies, aiding the cloud instance in delivering services to the Thin Client 120. That is, the Edge Nodes 110A-110N may ensure that latency is at or below a threshold level for the Thin Client 120 by providing various network functions as described above. Thin Client 120 and/or Edge Node 110A-110N may report their latency or other user experience metrics to the Load Manager 105. If the reported latencies are higher than the high-threshold, then the load manager redirects the Thin Client 120 to an edge node that has a lower latency. For example, the Thin Client 120 may be using edge node 110A. When the reported latencies for the Thin Client 120 exceed the established threshold, the Thin Client 120 may be switched to use Edge Node 110B. To be sure FIGS. 3 and 4 collectively illustrate the shifting of edge node services from one existing edge node to another existing edge node, which is contrasted with the process collectively illustrated in FIGS. 1 and 2. Again, FIGS. 1 and 2 collectively illustrate the shifting of edge node services from an existing, but latency challenged edge node to a newly instantiated edge node.

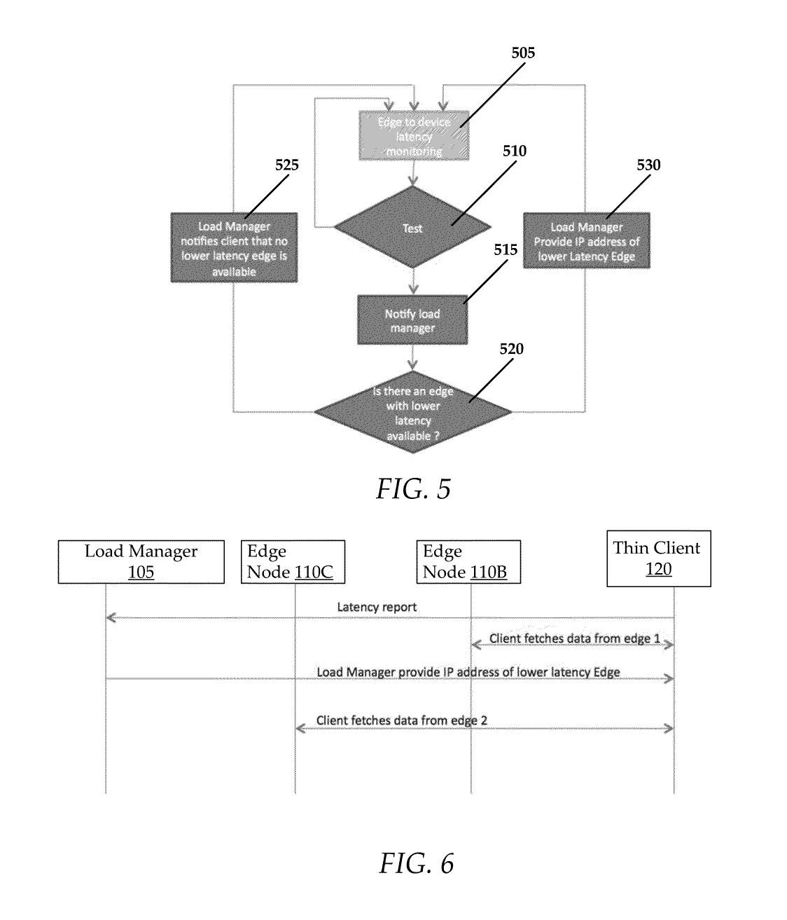

FIG. 5 is a flowchart of an exemplary method for providing services to a client in such a way that latency experienced by the client is reduced. The method includes clients reporting 505 their latency to the load manager, which is configured to monitor latency. The latency is tested 510 against the established thresholds to determine 515 if the load manager should be notified. If the latency is unacceptable, the load manager determines 520 if there is another node with lower latency available. If there is not another node with lower latency available, the load manager informs 525 the client that no additional network nodes are available. If another node with a lower latency is available, the load manager will transmit 530 to the client a message that includes the IP address of the new network node.

FIG. 6 is a signal flow diagram that illustrates the Load Manager 105 receiving a latency report from a Thin Client 120. This process may be continual or occur at specified intervals. Initially, the Client fetches data from Edge Node 110B. If latency for the Thin Client 120 exceeds acceptable values, the Load Manager 105 informs the Thin Client 120 to switch edge nodes by transmitting a signal to the Thin Client 120 that includes an IP address of a lower latency edge node, such as Edge Node 110C. The Thin Client 120 then begins to fetch data from Edge Node 110C. The Load Manager 105 may publish to the Thin Client 120 the address of more than one edge node so that the Thin Client 120 has the flexibility to test the latency to the other edge nodes recommended by the Load Manager 105. The Thin Client 120 can then as appropriate switch between these Edge Nodes as latency fluctuates.

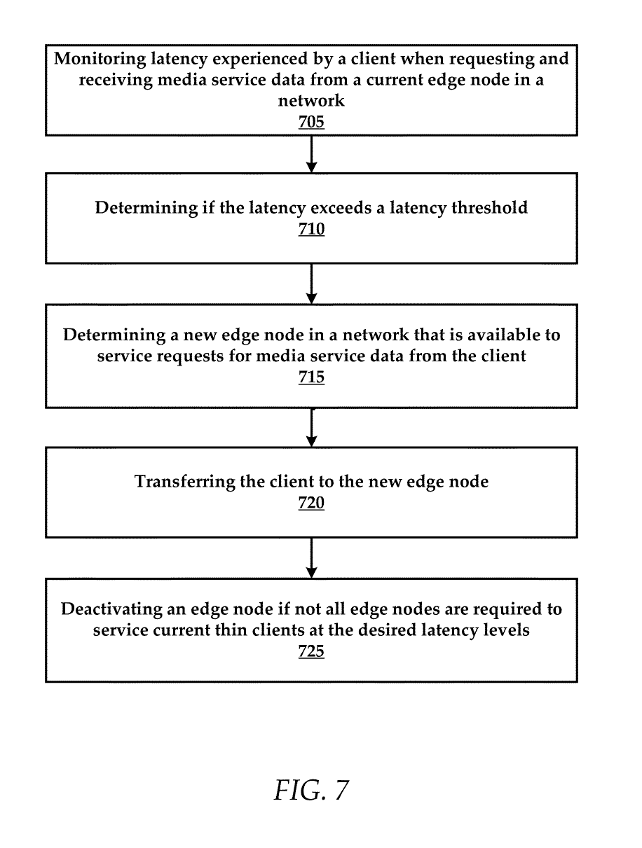

FIG. 7 is a flowchart of an example method of the present technology. In some embodiments, the method can be executed by a load manager of the present technology.

The method includes monitoring 705 latency experienced by a client when requesting and receiving media service data from a current edge node in a network.

In some embodiments, the method includes determining 710 if the latency exceeds a latency threshold. If the actual latency exceeds the latency threshold, the method includes determining 715 a new edge node in a network that is available to service requests for media service data from the client. To be sure, the new edge node will have a latency that does not exceed the latency threshold.

In some non-limiting examples, a latency threshold can be set to approximately fifty milliseconds. This latency threshold can reference a desired latency that exists between the thin client and the edge node.

For example, latency can be defined as a node and client time period extending between a request being transmitted by the client to the current edge node and a response to the request being provided by the current edge node to the client.

In another example, latency is defined as also including an overall time period that includes a request being transmitted by the client to the current edge node, fulfillment of the request by the current edge node and the back office, and receipt of a response to the request by the thin client. To be sure, the overall latency should be less than or equal to 250 milliseconds.

If a new edge node is available, the method includes transferring 720 the client to the new edge node. As mentioned above, the new edge node can include an existing edge node or a newly created edge node if no existing edge nodes are available.

In some embodiments, the method can comprise deactivating 725 an edge node if not all edge nodes are required to service current thin clients at the desired latency levels.

It will be understood that the while the embodiments described above involve the use of the present technology to deliver media services to customers, the present technology can be utilized in the provision of home security services, home automation services (e.g., smart home services), smart grid technology, smart city and infrastructure, and electronic healthcare services—just to name a few.

FIG. 8 is a schematic diagram of an example edge node 800. The edge node 800 generally comprises a service acceleration layer 802, a service acceleration API layer 804, and an accelerated service layer 806. It is noteworthy that the edge node 800 is configured to provide two accelerated services, in this embodiment, namely an accelerated entertainment service and an accelerated home security service.

Broadly speaking, the edge node 800, in some embodiments, utilizes two different API types. A first API type is utilized to manage the deployment and teardown of service acceleration applications. A second API type is utilized by the service acceleration applications such that they can leverage for an efficiency or advantage. For example, the edge node can use a local database and associated services like search features. Prioritized service oriented data collection can be aggregated by the service acceleration store for the purpose of providing analytics and five-nines uptime. Through this set of APIs, new converged services acceleration app can be created. For example as your security camera detects motion, the video from your security camera is forwarded to the TV while you are watching it as Picture-in-Picture. The service can also provide the user with the ability to take actions such as lock a door or sound an alarm. Another example scenario could be that recent in store purchases (geo location) influence the targeted advertisement presented to a thin client by the edge node.

Examples of service acceleration features are provided below in greater detail.

The service acceleration layer 802 generally includes, in some embodiments, an accelerated services manager 808, a search engine 810, a predictive search engine 812, a media processing module 814, a data processing and filtering engine 816, a targeted advertisement engine 818, a data store 820, an alarms processing engine 822, and an inter-edge communications interface 824.

The accelerated services manager 808 can utilize simple network management protocols SNMP and is tasked with communications between the edge node 800 and other edge nodes in the network.

The search engine 810 can be utilized to perform search operations for user requested search operations, for example, when users are searching for media content such as a movie or music.

The predictive search engine 812 is configured to provide predictive searching features for end users. For example, when a user begins to enter partial search parameters “The Soun”, the predictive search engine 812 can utilize predictive search features to provide a set of autocomplete selections such as “The Sound of Music” to the user. The predictive search engine 812 can select media assets for display that correspond to the autocomplete selection. In some embodiments, the user is presented with a list of autocomplete selections and the search engine 810 returns search results that include media assets for the selected search query.

The media processing module 814 is configured to provide media encoding, converting, and other similar media preparation functionalities that ensure that media delivered to the thin client is suitable for display on the type of device being utilized by the end user.

The data processing and filtering engine 816 is configured to collect data received from thin clients/end nodes primarily (but not exclusively) and locally process it to extract useful information that may then get used locally by the edge node to maximum acceleration service performance and/or drive key performance indicators associated with the services accelerated by the edge node.

The targeted advertisement engine 818 is configured to provide the thin client with targeted advertisements that corresponds to the preferences of the end user. The targeted advertisements can be based on any set of information such as user viewing history, user behaviors, purchases, and so forth.

The data store 820 can be utilized to cache media received from other the back office or other edge nodes. The data store 820 can also be utilized to store any type of data generated or received by the edge node 800.

The alarms processing engine 822 processes the home security messages and services provided to the thin client/end user. The alarms processing engine 822 employs any set of home security features that would be found in a home security and/or home automation system, as would be known to one of ordinary skill in the art with the present disclosure before them.

The inter-edge communication interface 824 provides a communications linkage between the edge node 800 and other edge nodes that are load manager has specified. For example, the load manager can coordinate the edge node 800 and one or more additional edge nodes to provide an accelerated service, such as an entertainment service. The inter-edge communication interface 824 can utilize a private inter-edge and back office API that allows the edge node 800, back office, and other edge nodes to communicate with one another.

The service acceleration API layer 804 provides a set of APIs 826 that are configured to service the numerous types of thin clients that the edge node will likely encounter. Multiple types of APIs may be necessary when thin clients use specific types of communication interfaces, operating systems, browser clients, and so forth.

The accelerated service layer 806 comprises the actual accelerated services which are delivered to a thin client. In this example, the accelerated service layer 806 comprises a home entertainment accelerated service 828 and a home security accelerated service 830. To be sure, the edge node 800 can be configured to provide additional or fewer services than those illustrated. Additional services can be accomplished through execution of service acceleration applications on the edge node 800. To be sure, the edge node 800 can utilize a public service acceleration store API to access the edge service store (see FIG. 1, edge service store 140).

In some embodiments, the edge node 800 comprises a device facing web services API that allows thin clients to communicatively couple with the edge node and receive one or more accelerated services, such as home entertainment accelerated service 828 and/or the home security accelerated service 830.

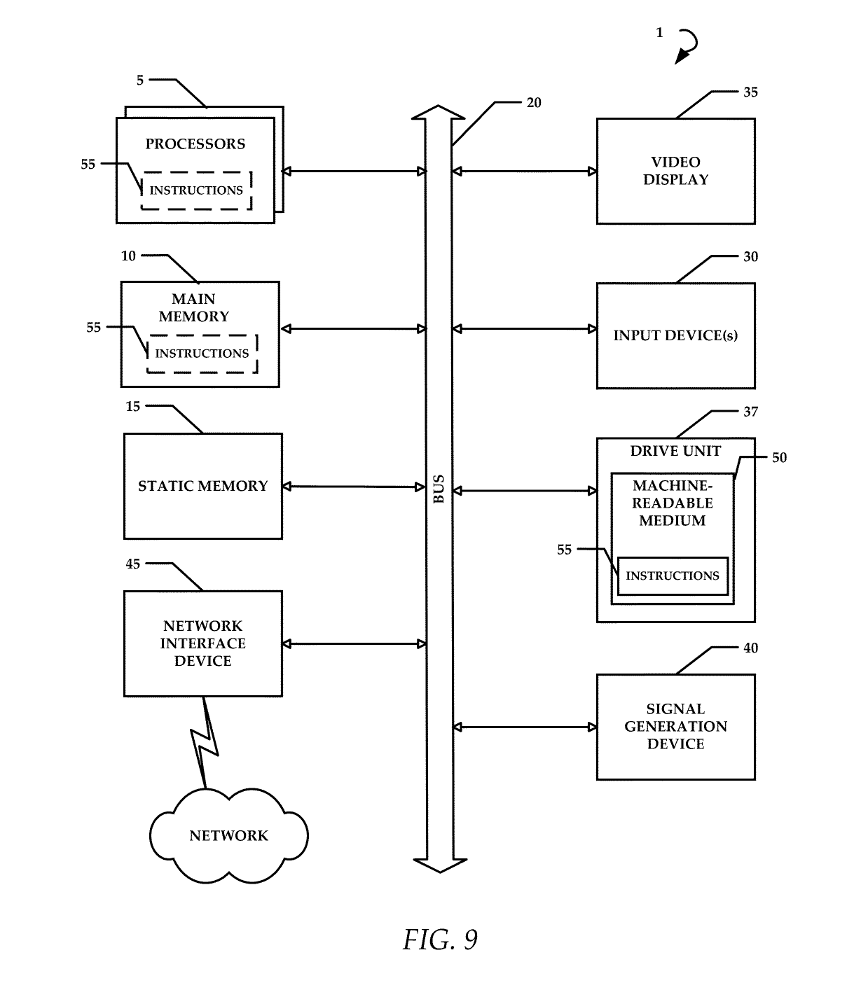

FIG. 9 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system, comprising:
a back office that provides a service; and
a service acceleration system comprising:
a plurality of geographically distributed edge nodes for a plurality of clients; and
a load manager that monitors latency experienced by each of the plurality of clients when requesting service data and selectively chooses one of the plurality of geographically distributed edge nodes for the plurality of clients based upon the latency experienced by each of the plurality of clients, wherein the latency is due to lack of central processing unit (CPU) availability in one or more of the plurality of the geographically distributed edge nodes and network traffic.

2. The system according to claim 1, wherein the load manager selectively chooses one of the plurality of geographically distributed edge nodes for a client by comparing a latency experienced by the client to a latency threshold and choosing a new node for the client when the latency exceeds the latency threshold.

3. The system according to claim 1, wherein the geographical distribution of the plurality of geographically distributed edge nodes is dynamically altered by the load manager based on latency calculations for the plurality of clients, wherein the load manager distributes the plurality of geographically distributed edge nodes to ensure that the latency of the plurality of clients is within a latency threshold.

4. The system according to claim 1, wherein the back office persistently maintains media service data.

5. The system according to claim 1, wherein the plurality of geographically distributed edge nodes stores the service data in cache memory to reduce latency for request for the service data from the plurality of clients.

6. The system according to claim 1, wherein each of the plurality of geographically distributed edge nodes are configured to cache metadata for the service data to improve delivery of electronic program (EPG) data, video on demand (VOD) data, and other outbound content metadata over a network.

7. The system according to claim 1, wherein the client comprises a set top box.

8. A load manager, comprising a processor and a memory for storing executable instructions, the processor executing the instructions to:
monitor latency experienced by a client when requesting and receiving media service data from a current edge node in a network, the current edge node being configured to:
receive a media service request from a client over a network;
provide the media service request to a back office that persistently maintains media service data;
configure the media service data for the client in such a way that the client need only display the media service data; and
transmit the configured media service data to the client;
determine if the latency exceeds a latency threshold;
determine a new edge node in a network that is available to service requests for media service data from the client, the new edge node having a latency that does not exceed the latency threshold; and
transfer the client to the new edge node.

9. The load manager according to claim 8, wherein the load manager is further configured to instantiate the new edge node if no existing edge nodes are available with a latency that does not exceed the latency threshold.

10. The load manager according to claim 8, wherein the current edge node and the new edge node are each configured with a first portion of a media services application, the first portion including all CPU intensive operations required to deliver a media service UI and media service data to a client.

11. The load manager according to claim 10, wherein the client includes a second portion of the media services application, the second portion being configured to display the media service UI, receiving user input, and display media service data.

12. The load manager according to claim 8, wherein the load manager is further configured to instantiate the new edge node on a server that is located within a given proximity to the client.

13. The load manager according to claim 8, wherein the latency threshold is approximately fifty milliseconds.

14. The load manager according to claim 8, wherein the latency is defined as a node and client time period extending between a request being transmitted by the client to the current edge node and a response to the request being provided by the current edge node to the client.

15. The load manager according to claim 8, wherein latency is further defined as also including an overall time period that includes a request being transmitted by the client to the current edge node, fulfillment of the request by the current edge node and the back office, and receipt of a response to the request by the client, wherein the latency should be less than or equal to 250 milliseconds.

16. The load manager according to claim 8, wherein the client comprises only an HTML application that receives user input and displays content received from the current edge node or the new edge node.

17. The load manager according to claim 8, wherein the load manager is further configured to:
detect display attributes of the client; and
configure the media service data for display on the client using the display attributes.

18. The load manager according to claim 8, wherein latency of the new node is based on CPU availability on the new node.

19. A method, comprising:
providing predictive search service in an edge node of a media service network, the media services network further comprising a back office that maintains persistent media service data, wherein the back office controls placement of the edge node within the media service network;
receiving textual input from a client communicatively coupled to the media service network;
executing a predictive search within the edge node using the textual input and predictive search dictionary; and
transmitting in real-time to the client predictive search results.

20. A thin client, comprising:
a processor; and
a memory for storing executable instructions, the processor executing the instructions to:
receive from load manager two or more IP addresses of edge nodes that are configured to provide media service data to the thin client, the edge nodes cooperating with a back office to deliver the media service data to the client;
actively determine latency between each of the edge nodes and the thin client that are related to provision of the media service data to a user; and
dynamically switch between edge nodes based on the latency.
